(19) United States
(12) Patent Application Publication
(10) Pub. No.: US 2025/0223170 A1
(43) Pub. Date: Jul. 10, 2025

(54) PROCESS FOR IN-SITU FUNCTIONALIZATION OF GRAPHENE

(71) Applicant: NanoXplore Inc., Montreal (CA)

(72) Inventors: Leroy MAGWOOD, Rancho Cucamonga, CA (US); Scott MURRAY, East Lansing, MI (US); Trent HINZE, St. Johns, MI (US)

(21) Appl. No.: 19/092,798

(22) Filed: Mar. 27, 2025

Related U.S. Application Data
(63) Continuation of application No. 18/601,495, filed on Mar. 11, 2024, now Pat. No. 12,286,353.
Application No. 18/601,495 is a continuation of application No. 17/613,194, filed on Nov. 22, 2021, now abandoned.
(60) Provisional application No. 62/851,774, filed on May 23, 2019.

(51) Int. Cl. C01B 32/19; B29C 45/00

(52) U.S. Cl. CPC C01B 32/19; B29C 45/0013; B29K 2995/0093

(57) ABSTRACT

A process for in situ functionalization of graphene including placing a graphitic precursor in an exfoliation cannister with exfoliation media; creating an inert atmosphere in the exfoliation cannister; exfoliating the graphitic precursor to form graphene having carboxyl moieties; and reacting the carboxyl moieties in the exfoliation cannister under conditions, such as a temperature of between 260 and 500° C., and in the presence of a substance to chemically reduce or react the carboxyl moieties during the exfoliating to produce hydrophobic graphene. Additionally, a process of molding an article including intermixing a thermoplastic in a molten state with hydrophobic graphene produced by an in situ functionalization process to form a dispersion of the hydrophobic graphene in the thermoplastic; injecting a melt of the dispersion of the hydrophobic graphene in the thermoplastic into a mold having a cavity complementary to the article; and allowing the melt to cool to form the article.

### CROSS-REFERENCE TO RELATED APPLICATION

This application claims priority of U.S. Provisional Patent Application Ser. No. 62/851,774 filed May 23, 2019, which is incorporated herein by reference.

### TECHNICAL FIELD

The present invention generally relates to graphene, and more specifically to a process for producing reduced hydrophilicity of graphene.

### BACKGROUND

During the preparation of graphene, interlayer bonds are sheared and otherwise broken to create labile networks, both in the basal plane and edges of the graphene platelet. A variety of techniques have been developed to chemically modify graphene to add or otherwise react moieties present on graphene platelets. These prior efforts have included efforts to modify electrical properties, water solubility, Friedel-Crafts alkylation, Diels-Alder reactions by reacting hydroxyl groups or unsaturations present on the graphene or graphene oxide platelets. (C. Chua et al., Chem. Soc. Rev. 2014, 43, 291-312; A. Abdolmaleki et al., RSC Adv., 2014, 4, 60052-60057). A common feature of these techniques is that the reactions occur subsequent to synthesis and as a result, add cost and limit throughput of the resulting material.

The existing process of ball milling has previously been used to functionalize graphene in situ during milling of a graphitic starting material but has meet with limited success owing to a lack of chemical control over the functional groups that are introduced. (Baek et al, J. Mater. Chem. A, 2014, 2, 8690-8695).

Thus, there exists a need for a refined in situ process to remove hydrophilic moieties or react such moieties to otherwise render them less hydrophilic. There also exists a need for the resulting material as a dispersant in hydrophobic matrices.

### SUMMARY OF THE INVENTION

The present invention provides a process for in situ functionalization of graphene that includes placing a graphitic precursor in an exfoliation cannister with exfoliation media; creating an inert atmosphere in the exfoliation cannister; exfoliating the graphitic precursor to form graphene having carboxyl moieties; and reacting the carboxyl moieties in the exfoliation cannister under conditions, such as a temperature of between 260 and 500° C., and in the presence of a substance, such as a catalyst, to chemically reduce or react the carboxyl moieties during the exfoliating to produce hydrophobic graphene.

The present invention also provides a process of molding an article that includes intermixing a thermoplastic in a molten state with hydrophobic graphene produced as described herein to form a dispersion of the hydrophobic graphene in the thermoplastic; injecting a melt of the dispersion of the hydrophobic graphene in the thermoplastic into a mold having a cavity complementary to the article; and allowing the melt to cool to form the article.

### BRIEF DESCRIPTION OF THE DRAWINGS

The present invention is further detailed with respect to the following drawings that are intended to show certain aspects of the present of invention, but should not be construed as limit on the practice of the invention, wherein:

FIG. 1 is a prior art chemical structure of a monolayer of graphene with carboxylated edges;

FIG. 2 is the chemical structure of FIG. 1 modified by an embodiment of the inventive process; and

FIG. 3 is a prior art exfoliation cannister operative in processes of the present invention.

### DETAILED DESCRIPTION

The present invention has utility as an improved process to functionalize graphene in situ during an exfoliation production. The resulting materials are hydrophobic compared to conventionally exfoliated graphenes. In particular, deoxygenation, or otherwise chemically reducing graphene as it is being exfoliated from a graphitic starting material yields the hydrophobic graphene material. The resulting material is particularly well suited for dispersion in hydrophobic materials such a thermoplastics, aliphatic oils and greases, perfluoropolymers, and polysilicones.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

A graphene monolayer is a crystalline allotrope of carbon in which each carbon atom is bound to three adjacent carbon atoms (sp²-hybridized) so as to define a one atom thick planar sheet of carbon. Graphene is often referred to as a two-dimensional structure because it represents a single sheet or layer of carbon of nominal (one atom) thickness. Multiple layers of graphene can be present to form a stack.

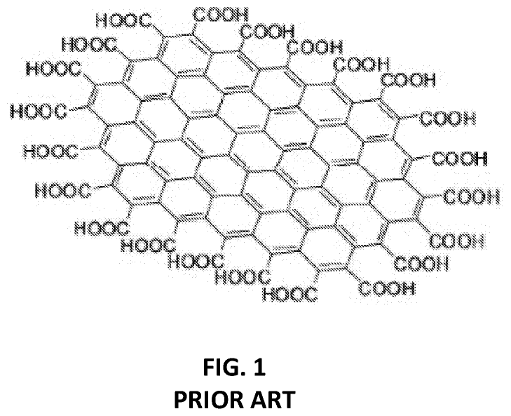

Graphene material conventionally produced through exfoliation of a graphitic starting material has carboxyl content. While this is shown as a prior art structure in FIG. 1 with edge carboxylation, it is appreciated that the edge carboxylation need not be complete. It is further appreciated that carboxylation defects are also present on sites in the basal plane of the graphene layer. Regardless of the location, carboxylation adds to the hydrophilicity of the graphene and disrupts the electron conduction relative to a purely aliphatic graphene.

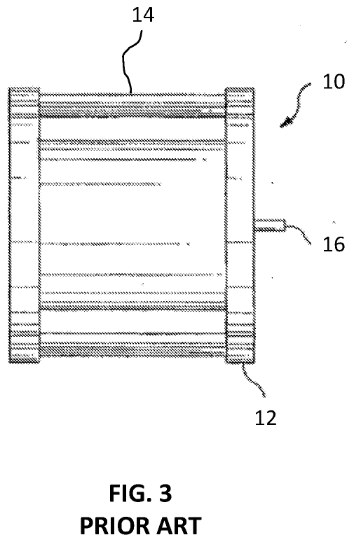

The present invention relies on a gas phase reaction during the exfoliation of a graphitic starting material to produce an inventive hydrophobic graphene, as compared to a conventional exfoliated graphene. An inventive process occurs through a controlled environment in an exfoliation apparatus. An exfoliation apparatus that can be adapted for performing an inventive process include conventional ball milling equipment, as well as that detailed in US Patent Application Publication US2016/0201784A1 with the proviso that the atmosphere during exfoliation is controlled. A prior art cannister operative with an inventive process is shown generally at 10 in FIG. 3. The cannister 10 has a cap 12 that is selectively removed to include exfoliation media, such as milling balls and graphitic precursors. The cap 12 upon sealing to the body 14 of the cannister 10 forms a gas tight seal. An atmospheric control valve 16 is provided to allow for controlled evacuation, purging, and addition of a gaseous reactant. As the kinetics of gas phase reactions according to some embodiments of the present invention are temperature dependent, is appreciated that a cannister 10 that is adapted to be heated offers additional options for controlling reaction rates and in some instances, the dominant reaction.

In a particular inventive embodiment, a decarboxylation reaction or any like reaction that would terminate moieties with aliphatics on the surface of the graphene at the expense of carboxyl moieties is of value for the purposes of compatibilization of graphene in thermoplastic matrices.

A gas phase decarboxylation reaction occurs under an inert atmosphere at elevated temperatures of 300 to 500° C. Such an atmosphere is oxygen free and illustratively includes nitrogen, argon, carbon dioxide, ethylene gas, fluorinated gases, and phosphorus containing gases. Typically, unimolecular decarboxylation occurs with a catalyst such as palladium, rhenium, iron trichloride, cyclohexanone, or combinations thereof in the exfoliation cannister. (W. Wang et al., ASME. J. Energy Resour. Technol. 2012; 134(3):032203-032203-7). It is appreciated the catalyst can then be used with the resulting decarboxylated graphene that acts as a support for the catalyst to perform subsequent catalytic reactions. It has been discovered that the decarboxylation of the graphene substrate during the exfoliation process results in higher rates of catalytic reactions that include functionalization of nitrogen, acrylates, and epoxies, as compared to carboxylated graphene. It has further been discovered that the use of ethylene gas or other gases that impart hydrophobicity provides graphene that is more easily incorporated into thermoplastics. Without intending to be bound to a particular theory, the carboxyl groups are repulsive to hydrophobic reactants and removal the carboxyl groups increase the active surface area of available for reaction and the reaction of hydrophilic groups of the graphene with one of the aforementioned gases to render these groups hydrophobic.

The inclusion of a catalyst in some inventive embodiments functions to promote alkane, alkene, or allyl incorporation into the graphene during the exfoliation production of the graphene. When alkanes, alkenes, allylics, or precursors therefor that gaseous or liquid under standard temperature and pressure (STP) (273 K, 1 atmosphere) are present in the atmosphere of the exfoliation cannister during the exfoliation production of the graphene.

In still other embodiments, the carboxylic acid specific reagent, N-cyclohexyl-N′-(2-morpholinoethyl)carbodiimide (CMC) is introduced during exfoliation under atmospheric conditions that favor reaction. (B. Prentice et al. J Am Soc Mass Spectrom. 2013; 24(1):30-37). The resulting amide bonds are amenable to reaction including polymerization.

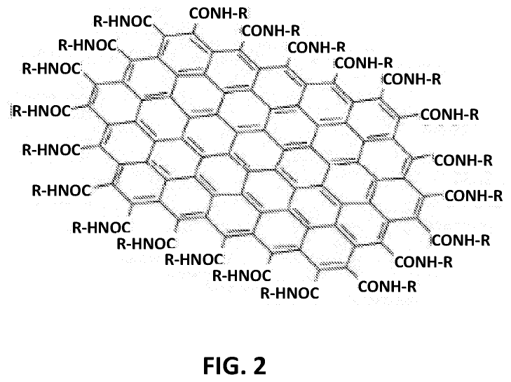

In other inventive embodiments, proximal carboxyl groups condense to form at an anhydride by exfoliating in a cannister heated to a temperature of between 260 to 400° C., and in still other embodiments at between 270 to 350° C., with a release of steam. The resulting anhydride groups are quite reactive compared to carboxyl groups and react with the gas phase introduction of a primary amine, NH₂-R creates an amide bond, CONH-R with the release of water as steam. (C. Moreno-Castillo et al., Carbon 1998; 36(1-2): 145-151). According to certain embodiments of the present invention, the primary amine is introduced into the exfoliation cannister after anhydride formation, as a gas, vapor or a liquid. The primary amine in some inventive embodiments is selected to yield a hydrophobic character to the resulting amide bond through selection of the extending R group. R groups operative herein include C₁-C₈ alkyls, C₂-C₆ alkenyls, C₆-C₁₂ aryls, and any of the aforementioned with a pendant moiety of C₆ aryl, methyl, ethyl, in place of a hydrogen atom. A graphene monolayer produced with the carboxylates of FIG. 1 reacted to create the amides CONH-R are shown in FIG. 2.

The resulting the layers of hydrophobic graphene range between 1 nm to 50 nm thickness. In still other embodiments, the layers of graphene range between 4 nm to 15 nm.

The functionalized graphene of the present invention presents a variety of advantages over similar materials taught by the prior art. Specifically, while high-energy ball-milling techniques used in the prior art tend to create carboxylate moieties in basal plane of graphene as well as in edge positions, the present invention reacts these carboxyl moieties during the exfoliation process of a graphitic precursor to render these moieties as chemically reduced aliphatics or otherwise as hydrophobic moieties. Without wishing to be bound to a particular theory, existing ball-milling techniques tend to introduce carboxyl moieities at sites where C—C bonds are fractured by the mechanical force of milling. As this is believed to be a lower energy occurrence in the basal plane relative to an edge, yet control is limited resulting in defects in both basal and edge sites. These defects are high energy sites and are susceptible to reaction with atmospheric moisture and/or oxygen, thereby resulting in the formation of the undesirable carboxyl moieties.

In specific inventive embodiments grafts are made to in-plane defects of the graphene.

In specific inventive embodiments microwaves are used for decoration with lithium or other metals to create controlled three dimensional (3D) graphene structures.

In some inventive embodiments, the graphene produced by the present invention is removed from the exfoliation cannister and filtered so as to separate the as produced graphene as to purity, size or a degree of functionalization, or a combination thereof. Filtration techniques operative herein include solvent extraction, size exclusion chromatography, affinity chromatography, and combinations thereof. To the extent that a dry powder is required, a filtrate is readily lyophilized to a dry powder. Chromatography media operative herein illustratively include silica, alumina, titania, resin beads, and chemically modified versions thereof.

Purification of the hydrophobic graphene in some embodiments also includes washing the exfoliated hydrophobic graphene in a solvent to preferentially suspend or dissolve contaminants thereto or graphene material as a function of hydrophilicity. The resulting washed material is readily dried in a stream of inert gas or via vacuum drying.

### EXAMPLES

### Example 1

Graphite material is loading into a cannister per US Patent Application Publication US2016/0201784A1. Palladium particulate with a diameter of 100 nm is added to 0.05 total weight percent of the graphitic material. (J. Turkevich et al., Science 1970, 169(3948): 873-879). The cannister is sealed by joining the cap and the evacuated. An atmosphere of argon is introduced and the canister is rotated at for 16 hours at a temperature of 350° C. Upon cooling, the cannister is opened and the graphene separated from the milling media.

### Example 2

The procedure of Example 1 is repeated with an ethylene atmosphere in place of argon to obtain a modified graphene.

### Example 3

The material produced by Example 1 is dispersed in a melt of polyethylene with a uniform dispersion being observed in the resulting cooled pellets formed from the melt. For comparison, conventional graphene produced by the procedure of Example 1 absent the palladium catalyst does not fully disperse under the same conditions in the same melt of polyethylene.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1-11. (canceled)

12. A method comprising:
exfoliating a graphitic precursor in a controlled gas environment to form a first graphene having carboxyl moieties; and
reducing concentration of carboxyl moieties of the first graphene in presence of a substance in the controlled gas environment to obtain a second graphene, the second graphene being more hydrophobic compared to the first graphene.

13. The method of claim 12, wherein exfoliating the graphitic precursor occurs at least partially concurrently with reducing the concentration of carboxyl moieties of the first graphene.

14. The method of claim 12, wherein reducing the concentration of carboxyl moieties of the first graphene occurs after exfoliating the graphitic precursor.

15. The method of claim 12, wherein exfoliating the graphitic precursor is via ball milling.

16. The method of claim 12, wherein reducing the concentration of carboxyl moieties of the first graphene includes at least one of chemically reducing or reacting the carboxyl moieties.

17. The method of claim 12, wherein reducing the concentration of carboxyl moieties of the first graphene includes a gas phase decarboxylation reaction.

18. The method of claim 12, wherein the controlled gas environment is inert.

19. The method of claim 18, wherein the controlled gas environment includes nitrogen.

20. The method of claim 12, wherein the controlled gas environment is at a temperature ranging from 260° C. to 500° C.

21. The method of claim 12, wherein the substance includes a catalyst.

22. The method of claim 21, wherein the catalyst includes at least one of palladium, iron trichloride, or cyclohexanone.

23. The method of claim 21, wherein the substance further comprises at least one of an alkane, an alkene, or an allyl.

24. The method of claim 12, wherein the substance includes a reagent of N-cyclohexyl-N′-(2-morpholinoethyl)carbodiimide (CMC).

25. The method of claim 12, further comprising:
forming an intermediate anhydride via reacting the carboxyl moieties of the first graphene.

26. The method of claim 25, further comprising:
reacting the intermediate anhydride with a primary amine to form an amide.

27. The method of claim 12, further comprising:
mixing the second graphene with a thermoplastic in a molten state to form a dispersion of the second graphene in the thermoplastic;
injecting a melt of the dispersion of the second graphene in the thermoplastic into a mold having a cavity complementary to an article; and
allowing the melt to cool to form the article.

28. A method comprising:
exfoliating a graphitic precursor to form a first graphene having carboxyl moieties; and
reacting carboxyl moieties of the first graphene in presence of a substance to chemically reduce or react the carboxyl moieties, thereby obtaining a second graphene, the second graphene being more hydrophobic compared to the first graphene.

29. The method of claim 28, wherein exfoliating the graphitic precursor occurs at least partially concurrently with reacting carboxyl moieties of the first graphene.

30. The method of claim 28, wherein reacting carboxyl moieties of the first graphene occurs after exfoliating the graphitic precursor.

31. The method of claim 28, wherein at least one of exfoliating the graphitic precursor or reacting carboxyl moieties of the first graphene occur in a controlled gas environment.

32. The method of claim 31, wherein the controlled gas environment includes nitrogen.

33. The method of claim 28, wherein exfoliating the graphitic precursor is via ball milling.

34. The method of claim 28, wherein the substance includes a catalyst, the catalyst including at least one of palladium, iron trichloride, or cyclohexanone.

35. The method of claim 34, wherein the substance further comprises at least one of an alkane, an alkene, or an allyl.

36. The method of claim 28, further comprising:
condensing the carboxyl moieties to form an intermediate anhydride.

37. The method of claim 36, further comprising:
reacting the intermediate anhydride to form an amide.
